(19) United States
(12) Patent Application Publication
(10) Pub. No.: US 2026/0319721 A1
(43) Pub. Date: Oct. 15, 2026

(54) INFORMATION PROCESSING APPARATUS, PRINTING APPARATUS, CONTROL METHOD, AND STORAGE MEDIUM

(71) Applicant: CANON KABUSHIKI KAISHA, Tokyo (JP)

(72) Inventor: Takayuki Ochiai, Tokyo (JP)

(21) Appl. No.: 19/629,234

(22) Filed: Mar. 26, 2026

(30) Foreign Application Priority Data
Apr. 1, 2025 (JP) 2025-060582

(51) Int. Cl. G06F 3/12; B41J 3/46; B41J 29/393

(52) U.S. Cl. CPC G06F 3/1254; B41J 3/46; B41J 29/393; G06F 3/1204; G06F 3/1236

(57) ABSTRACT

An object of the present disclosure is to shorten a time for an initial setup of an information processing apparatus. An embodiment of the present disclosure is an information processing apparatus including a control unit configured to execute preparation processing and parameter setting processing of setting a parameter in accordance with a parameter setting method selected from a plurality of parameter setting methods, wherein in a case where a parameter setting method selected from the plurality of parameter setting methods is a method which does not require reactivation, the control unit executes the preparation processing and the parameter setting processing in parallel.

### BACKGROUND

### Field of the Technology

The present disclosure relates to an information processing apparatus, a printing apparatus, a control method, and a storage medium.

### Description of the Related Art

In a printing apparatus configured to print an image with an ink, it takes a long time for filling an ink flow passage with an ink at the time of an initial setup (so-called ink initial filling). Japanese Patent Laid-Open No. 2008-21251 discloses a technology for shortening a time for an initial setup by performing setting relating to a connection interface with an external device in parallel with ink initial filling and the subsequent maintenance operation of a printing mechanism during a flow of the initial setup of a printing apparatus.

Incidentally, controllers of printing apparatuses are implemented in accordance with a wide variety of architectures, and some controllers to be used require reactivation of printing apparatuses during execution of processing relating to the setting of interfaces.

### SUMMARY

However, in the case where the technology of Japanese Patent Laid-Open No. 2008-21251 is applied to a printing apparatus equipped with a controller as described above, there occurs a case where the printing apparatus is reactivated during execution of print preparation processing including ink initial filling and maintenance operation. In this case, there is a risk that the ink is excessively consumed, or a hardware failure occurs. For this reason, the print preparation processing and the processing relating to the setting of interfaces cannot be simultaneously executed, and the time for the initial setup cannot be shortened.

Hence, in view of the above-described problem, an object of the present disclosure is to shorten a time for an initial setup of an information processing apparatus.

An embodiment of the present disclosure is an information processing apparatus including a processor; and a memory storing instructions that, when executed by the processor, cause the processor to perform operations comprising executing preparation processing, and executing parameter setting processing of setting a parameter in accordance with a parameter setting method selected from a plurality of parameter setting methods, wherein in a case where a parameter setting method selected from the plurality of parameter setting methods is a method which does not require reactivation, the preparation processing and the parameter setting processing are executed in parallel.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a schematic internal configuration of a printing apparatus according to a first embodiment;

FIG. 2 is a perspective view showing appearance of the printing apparatus according to the first embodiment;

FIG. 3 is a flowchart of print preparation processing according to the first embodiment;

FIG. 4 is an example of transition of GUI screens according to the first embodiment;

FIG. 5 is an example of transition of GUI screens according to the first embodiment;

FIG. 6 is a flowchart of print preparation processing according to a second embodiment;

FIG. 7 is an example of transition of GUI screens according to the second embodiment; and

FIG. 8 is an example of transition of GUI screens according to the second embodiment.

### DESCRIPTION OF THE EMBODIMENTS

Hereinafter, modes for carrying out the present disclosure will be described by using the drawings. Note that the relative arrangement, shapes, and the like of constituent elements of apparatuses used in the following embodiments are only examples, and are not intended to limit the present disclosure to these described. In addition, in the following description, repetitive description will be omitted as appropriate, and in the drawings, the same or similar configurations are denoted by the same reference signs.

### First Embodiment

### Configuration of Printing Apparatus

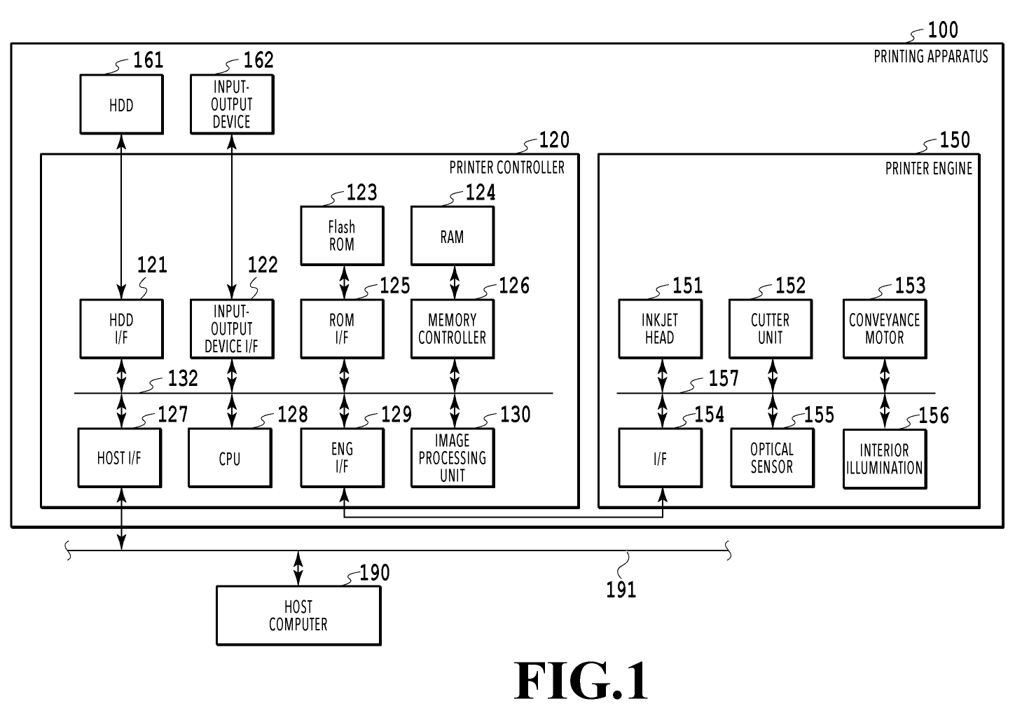

FIG. 1 is a block diagram showing a schematic configuration of a printing apparatus according to the present embodiment. Note that in the present embodiment, a printing apparatus having only a printing function is shown, but the printing apparatus is not limited to this. For example, the printing apparatus may be a printing apparatus further including a reading device configured to read an image on an original document to function as a copier, or may be a multi-function peripheral (MFP) equipped with other functions. In addition, the technology of the present embodiment can be applied to an information processing apparatus including a printing apparatus.

In FIG. 1, a printing apparatus 100 is configured by including a printer controller 120, a printer engine 150, an HDD 161, and an input-output device 162. In addition, the printing apparatus 100 can be connected to a host computer 190 via a network 191.

The printer controller 120 includes an HDD interface (I/F) 121, an input-output device I/F 122, a ROM I/F 125, and a memory controller 126. In addition, the printer controller 120 includes a host I/F 127, a CPU (Central Processing Unit) 128, a controller engine interface 129, and an image processing unit 130. These are connected via a system bus 132. Moreover, the printer controller 120 includes a Flash ROM 123 and a RAM 124, which are connected to the system bus 132 via the ROM I/F 125 and the memory controller 126, respectively.

The CPU 128 is a central processing unit in the form of a microprocessor (microcomputer), and controls the operation of the entire printing apparatus 100 by executing programs and activating hardware. The Flash ROM 123 stores programs to be executed by the CPU 128 and various pieces of data required for various operations of the printing apparatus 100. The RAM 124 is used as a work area for the CPU 128, is used as a temporary storage area for various pieces of reception data, and stores various pieces of setting data. The image processing unit 130 performs various image processings, and performs, for example, processing of developing (converting) print data (for example, data written in a page description language) to be handled in the printing apparatus 100 to image data (bitmap image data), and other image processings. In addition, the image processing unit 130 converts a color space (for example, YCbCr) of image data contained in inputted print data to a standard RGB color space (for example, sRGB). Moreover, the image processing unit 130 performs, on image data, various image processings such as resolution conversion to the number of effective pixels (on which the printing apparatus 100 can perform print processing), image analysis, and image correction as necessary. Image data obtained by these image processings is stored in the RAM 124 or the HDD 161.

The printer engine 150 is a printing unit configured to perform image printing. The printer engine 150 includes an inkjet head 151, a cutter unit 152, a conveyance motor 153, an interface 154 with the printer controller 120, an optical sensor 155, and an interior illumination 156. These units are connected via a system bus 157.

The inkjet head 151 is a printing unit configured to print an image, and prints an image on a printing medium based on print data generated based on image data. The inkjet head 151 holds, for example, printing heads for a plurality of colors, and ejects inks from the printing heads in synchronization with the conveyance of the printing medium to print an image on the printing medium. Note that here, the printing apparatus is described by giving, as an example, a printer of an inkjet system using inks as printing materials; however, the present embodiment is not limited to this printer. The present embodiment can be applied to printing apparatuses of various printing systems such as a thermal printer (such as a sublimation type or a heat transfer type), a dot impact printer, an LED printer, an electrophotographic system such as a laser printer.

The cutter unit 152 is, in the present embodiment, a mechanism configured to cut a roll sheet used as a printing medium for printing. The cutter unit 152 cuts the roll sheet after printing into a predetermined length. The conveyance motor 153 is a motor for driving a conveyance roller configured to convey the roll sheet, and is controlled by the CPU 128. The optical sensor 155 is a measurement unit for measuring attribute values of the printing medium, and is a reflective optical sensor configured by including an LED (Light Emitting Diode) as a light-emitting element, a specular reflected light-receiving element, a diffuse light-receiving element, and the like. The printing apparatus 100 measures attribute values such as intensities of specular reflected light and diffuse-reflected light of a sheet on a platen and the thickness of the sheet, by using the optical sensor 155. The interior illumination 156 is an LED configured to illuminate on the platen during printing or during works with the cover open such as at the time of cleaning the inside of the cover, and at the time of exchanging the inkjet head 151 or the cutter unit 152. The interior illumination 156 is controlled by the CPU 128 based on the state of the printer or the setting designated by the user.

The input-output device 162 includes an input unit such as hard keys or a panel for the user to perform various operations, and a display unit for displaying (presenting) various pieces of information to the user. In addition, the input-output device 162 may present information to the user by outputting sound (buzzer, audio, or the like ) based on sound information from an audio generator. At the time of sheet feeding, the user selects a sheet type by using the input-output device 162, and informs the printing apparatus 100 of a correct sheet type, so that the printing apparatus 100 can perform conveyance set for each sheet type.

The HDD 161 is a non-volatile storage area, and programs to be executed by the CPU 128, print data, setting information required for various operations of the printing apparatus 100 can be stored in the HDD 161 and read out from the HDD 161. Another large-capacity storage device such as a flash memory may also be used instead of the HDD 161 or together with the HDD 161. Note that in the present embodiment, the input-output device 162 is present inside the printing apparatus 100; however, the configuration is not limited to this. For example, the input-output device 162 may be connected as an external configuration via the network 191. In addition, the host computer 190 may function also as the input-output device 162. In addition, the printing apparatus 100 may be configured such that another input-output device can be connected to the printing apparatus 100 via the network 191 or the like besides the input-output device 162. The host computer 190 is, for example, an external apparatus serving as a supply source of print data, and a printer driver is installed in the host computer 190. As the connection destination of the printing apparatus 100, for example, a data provision apparatus which can function as a supply source of print data such as a reader for reading images, a digital camera, a smartphone, or the like may be provided instead of the host computer 190. The connection configuration between various devices and the printing apparatus 100 is not limited to a configuration via the network 191, but various devices and the printing apparatus 100 may be directly connected, for example, via a wireless communication.

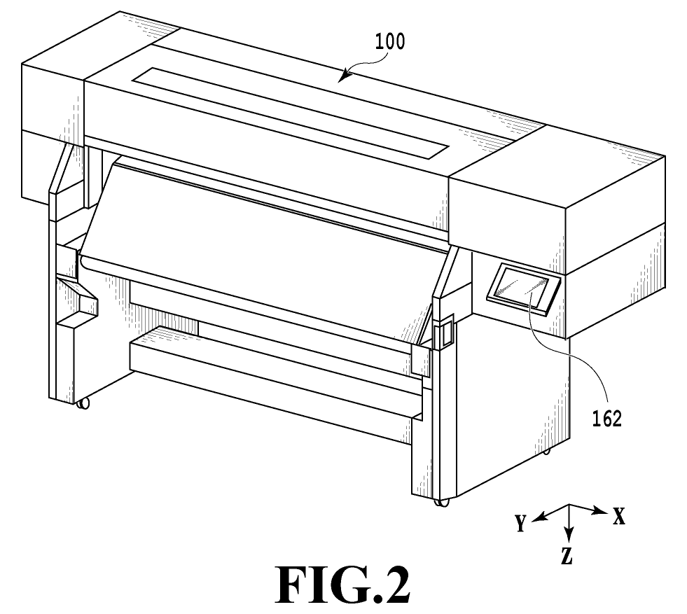

FIG. 2 is a schematic diagram of appearance of the printing apparatus 100 according to the present embodiment, and represents a positional relation of the printing apparatus 100 and an operation panel of the input-output device 162.

### Print Preparation Processing

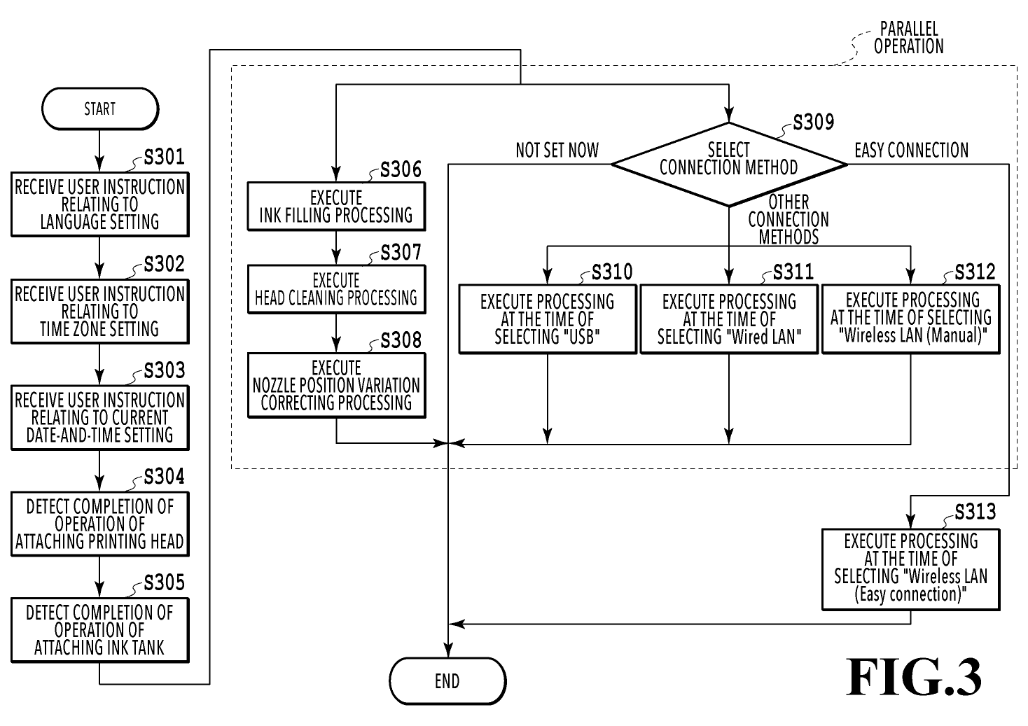

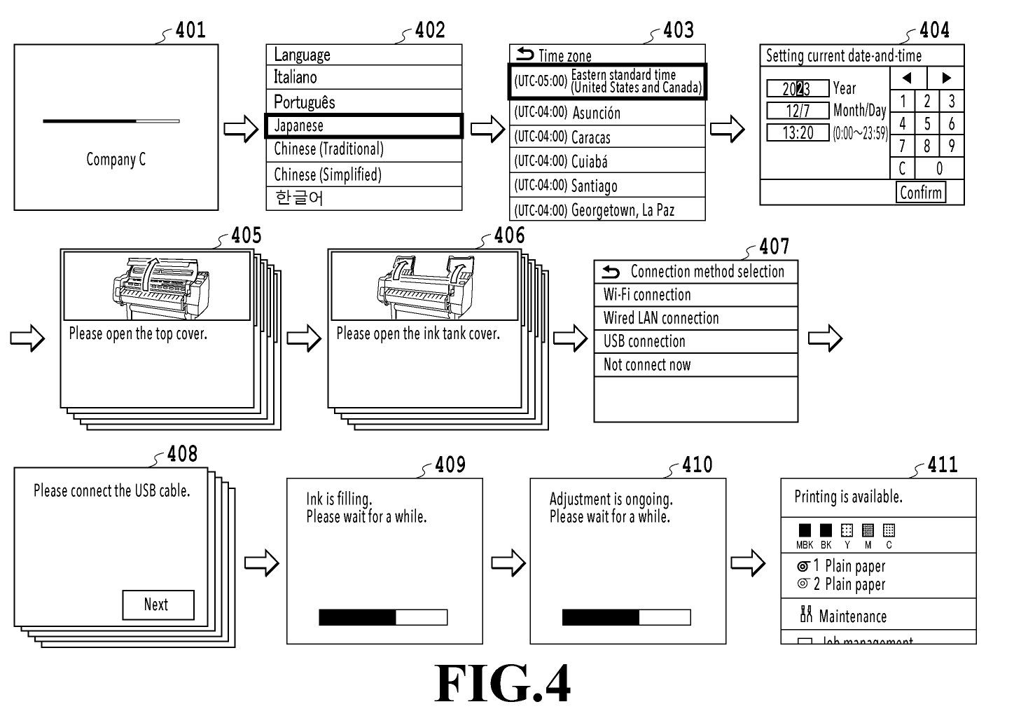

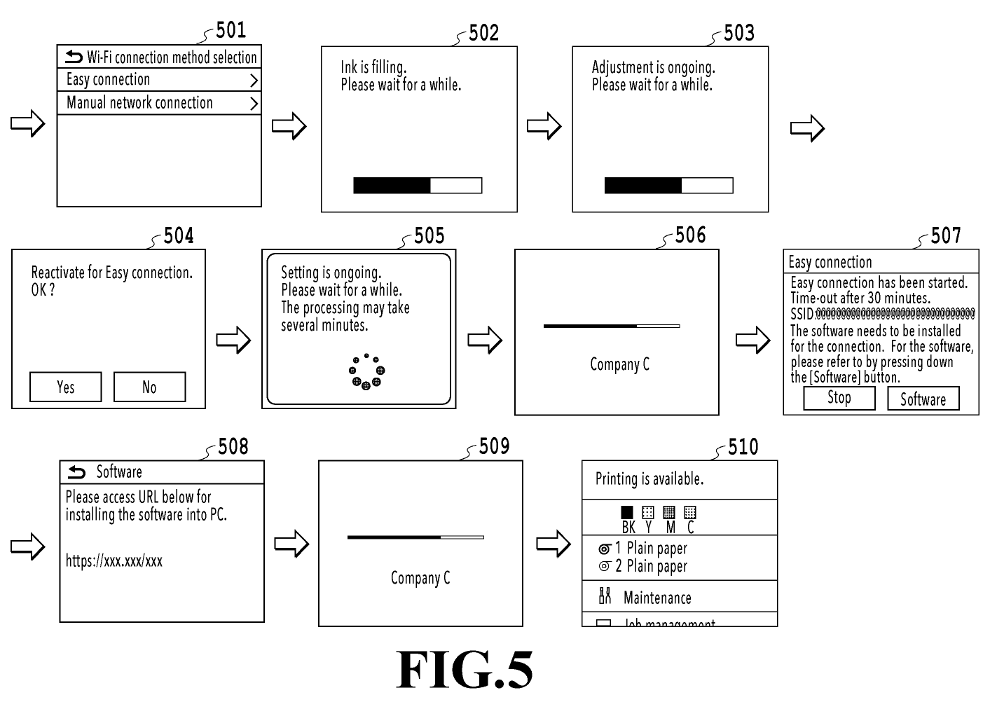

Hereinafter, print preparation processing to be executed in the printing apparatus 100 according to the present embodiment will be described by using FIGS. 3 to 5. FIG. 3 is a flowchart showing a flow of the print preparation processing according to the present embodiment. FIGS. 4 and 5 each show an example of transition of GUI screens to be displayed on the operation panel of the input-output device 162 in the print preparation processing according to the present embodiment.

After the printing apparatus 100 is installed into a user environment, in the case where power supply to the main body is initially turned on, the CPU 128 of the printer controller 120 starts the print preparation processing of FIG. 3. Once the print preparation processing is started, the CPU 128 displays a GUI screen 401. Note that information indicating whether or not an initial power supply has been turned on after the installation into the user environment is stored in a non-volatile storage unit such as the Flash ROM 123. Hence, by using this information, the CPU 128 can determine whether or not the activation by the latest turning on of the power supply was the initial activation after the installation into the user environment.

In step S301, the CPU 128 receives a user instruction relating to language setting, which is inputted via a GUI screen 402. Note that in the following, "step Sxxx" is abbreviated as "Sxxx".

In S302, the CPU 128 receives a user instruction relating to time zone setting, which is inputted via a GUI screen 403.

In S303, the CPU 128 receives a user instruction relating to current date-and-time setting, which is inputted via a GUI screen 404.

In S304, the CPU 128 displays a GUI screen 405 which prompts opening the top cover in attaching the printing head. Thereafter, in the case where completion of the operation of attaching the printing head is detected, the processing proceeds to S305.

In S305, the CPU 128 displays a GUI screen 406 which prompts opening the ink tank cover in attaching the ink tank. Thereafter, in the case where completion of the operation of attaching the ink tank is detected, the processing proceeds to S306 and S309. The processing in and after S306 and the processing in and after S309 are executed in parallel.

In S306, the CPU 128 executes ink filling processing of filling the ink tank with the ink. This ink filling processing includes display processing of a GUI screen 409, and after this ink filling processing ends, the processing proceeds to S307.

In S307, the CPU 128 executes head cleaning processing.

In S308, the CPU 128 executes nozzle position variation correcting processing. Note that while S307 and S308 are being executed, a GUI screen 410 indicating that adjustment is ongoing is displayed. After the nozzle position variation correcting processing of the present step ends, a series of processing ends, and a GUI screen 411 is displayed.

In S309, the CPU 128 displays a GUI screen such as a GUI screen 407, and determines which parameter setting method (a method for setting a connection parameter required for connecting with the external apparatus in the present example) has been selected by the user via the displayed GUI screen. Specifically, in the case where "USB" has been selected, the processing proceeds to S310. In the case where "Wired LAN" has been selected, the processing proceeds to S311. In the case where "Wireless LAN (Manual)" has been selected, the processing proceeds to S312. In addition, in the case where "Easy connection" has been selected, the processing proceeds to S313. In the case where "Not set now" has been selected, the series of processing ends.

Here, as an example of the case where the reactivation of the main body of the printing apparatus 100 during the setting is unnecessary, a flow of processing in the case where "USB" has been selected in S309 will be described. In the case where "USB" has been selected in S309, in S310, the CPU 128 displays GUI screens 408 which prompt connecting a USB cable. The GUI screens 408 are a group of a plurality of still screens functioning as screens for explaining an operation of connecting a USB cable (referred to as USB connection guide screens), and in S310, the plurality of still screens are sequentially displayed. Note that in the case where S306 is being executed at the time of the execution of S310, a GUI screen 409 is also displayed together. In this way, in the present embodiment, in the case of executing the parameter setting processing relating to the USB connection, it is unnecessary to reactivate the main body of the printing apparatus 100. In addition, also in the case of executing parameter setting processing relating to the wired LAN connection or parameter setting processing relating to the manual wireless LAN connection, it is unnecessary to reactivate the main body of the printing apparatus 100. For this reason, as shown in FIG. 3, in the case where these parameter settings have been selected, the parameter setting processing and the print preparation processing are executed in parallel. Here, part of the print preparation processing (S306 to S308) to be executed in parallel with the parameter setting processing is detrimental to the user in the case where the printing apparatus 100 is reactivated during the execution of the processing.

Next, as an example of the case where the reactivation of the main body of the printing apparatus 100 is necessary during the setting, the processing of S313 in the case where "Easy connection" has been selected in S309 will be described. This processing is, specifically, processing in the case where "Wi-Fi connection" has been selected via the GUI screen 407, and "Easy connection" has been selected via a GUI screen 501 (FIG. 5) which is displayed in accordance with this selection. Note that as other settings requiring the reactivation of the main body, "IPv6 effective/ineffective setting switching" and the like can be considered; however, the settings are not limited to these.

Before executing the processing of S313, the CPU 128 displays a GUI screen 502 in the case where the ink filling processing (S306) is being executed. Once this ink filling processing ends, the head cleaning processing is subsequently executed (S307), and the nozzle position variation correcting processing is executed (S308). During this, the CPU 128 displays a GUI screen 503. Then, after the processing of S308 ends, the processing of S313 is executed.

In S313, the CPU 128 displays a GUI screen 504. The user who has seen the GUI screen 504 instructs reactivation by pressing down a "Yes" button in the GUI screen 504. In the case where the input of pressing down this "Yes" button is received, the CPU 128 displays a GUI screen 505 indicating that setting is ongoing. After the setting ends, the main body of the printing apparatus 100 is reactivated, and the CPU 128 displays a GUI screen 506. Subsequently, after the reactivation processing is completed, the CPU 128 displays a GUI screen 507 for explaining a procedure of Easy connection. In the case where an input of pressing down a "Software" button in the GUI screen 507 is received, the CPU 128 displays a GUI screen 508 which is a guide screen for installing software. Thereafter, in the case where the user has executed a predetermined operation on the host PC side, the printing apparatus 100 is automatically reactivated, and the CPU 128 displays a GUI screen 509. After the reactivation, the CPU 128 displays a GUI screen 510 which is a standby screen.

As described above, in the present embodiment, in the case where a connection method which does not require the reactivation of the main body of the printing apparatus 100 is selected, the print preparation processing and the parameter setting processing are executed in parallel. This make it possible to shorten the time required for the initial setup by the time required for the parameter setting. In addition, in the case where a connection method which requires the reactivation of the main body of the printing apparatus 100 is selected, the parameter setting processing is executed after the print preparation processing ends. This make it possible to prevent a problem due to interruption of the print preparation processing from occurring.

### Second Embodiment

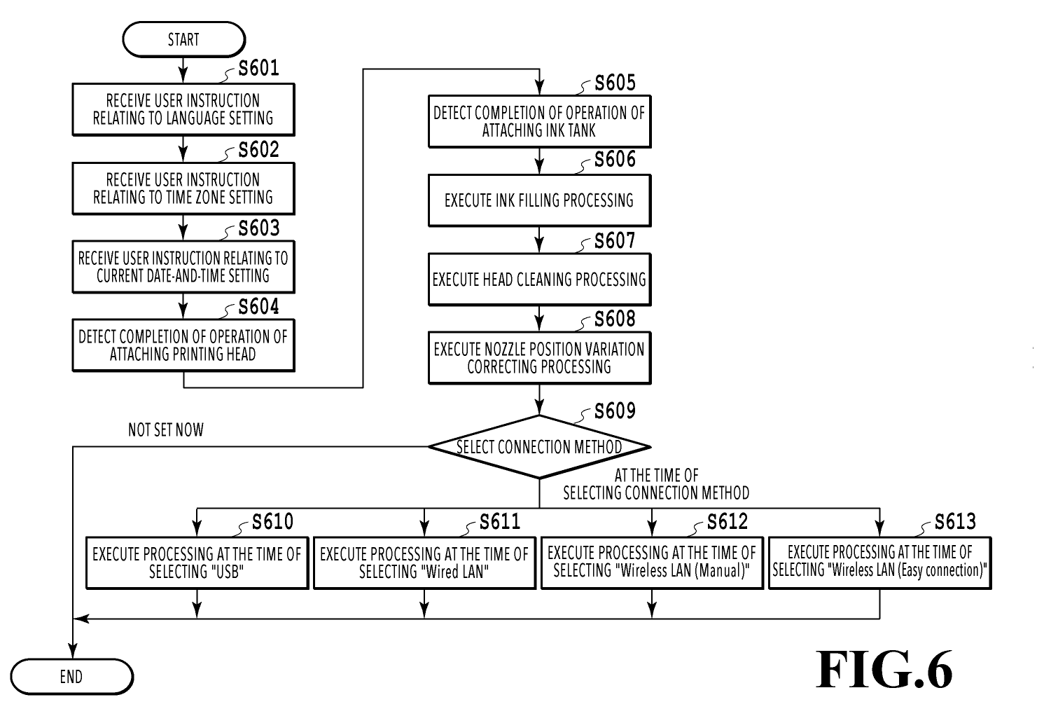

Hereinafter, a second embodiment according to the present disclosure will be described by using FIGS. 6 to 8. Note that points different from the aforementioned embodiment will be mainly described, and the description of the same points will be omitted as appropriate.

### Print Preparation Processing

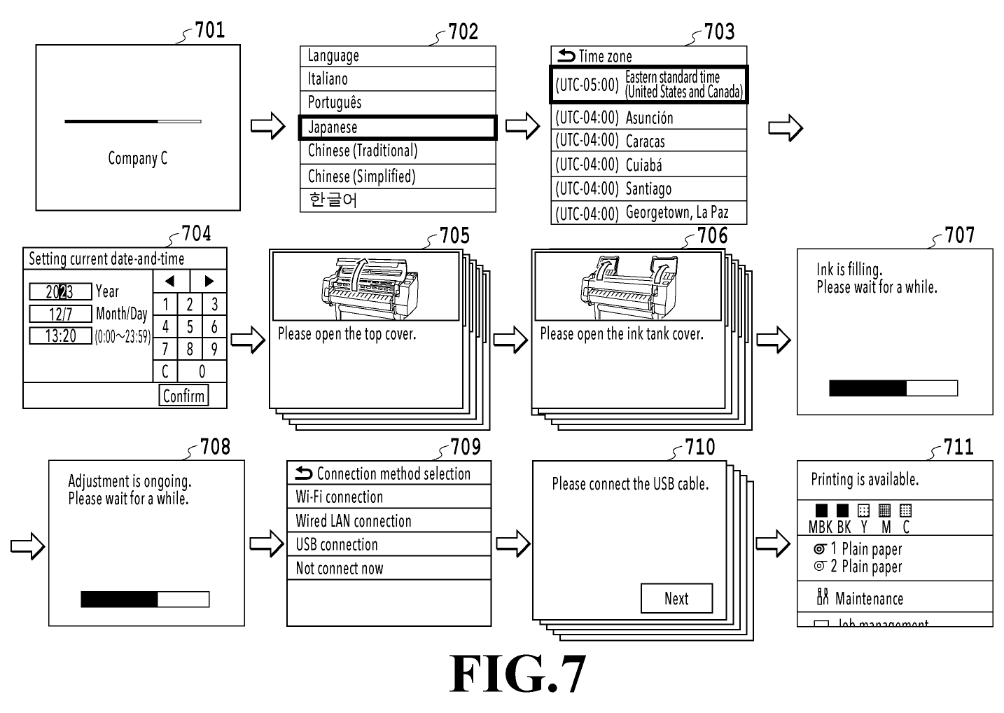

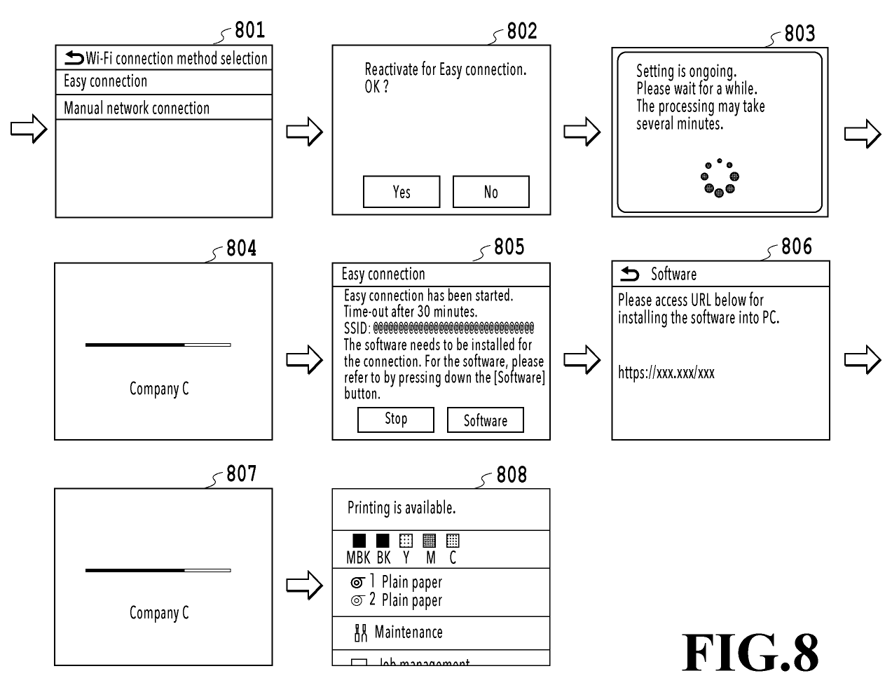

Hereinafter, print preparation processing to be executed in a printing apparatus 100 according to the present embodiment will be described by using FIGS. 6 to 8. FIG. 6 is a flowchart showing a flow of the print preparation processing according to the present embodiment. FIGS. 7 and 8 each show an example of transition of GUI screens to be displayed on the operation panel of the input-output device 162 in the print preparation processing according to the present embodiment.

After the printing apparatus 100 is installed into a user environment, in the case where the CPU 128 of the printer controller 120 has detected that a power button has been pressed down for a certain long period of time in initially turning on a power supply to the main body, the CPU 128 starts the print preparation processing of FIG. 6. Once the print preparation processing is started, the CPU 128 displays a GUI screen 701.

S601 to S605 are the same as S301 to S305 (see FIG. 3) of the first embodiment. As shown in FIG. 7, in S601 to S605, a GUI screen 702 to a GUI screen 706 are displayed in the same manner as in the first embodiment (see the GUI screen 402 to the GUI screen 406 in FIG. 4). In S605, in the case where the CPU 128 has detected that the operation of attaching the ink tank has been completed, the processing proceeds to S606.

In S606, the CPU 128 executes ink filling processing. This ink filling processing includes processing of displaying a GUI screen 707, and after the ink filling processing ends, the processing proceeds to S607.

In S607, the CPU 128 executes head cleaning processing.

In S608, the CPU 128 executes nozzle position variation correcting processing. Note that while S607 and S608 are being executed, a GUI screen 708 indicating that adjustment is ongoing is displayed. After the nozzle position variation correcting processing of the present step ends, the processing proceeds to S609.

In S609, the CPU 128 displays a GUI screen such as a GUI screen 709, and determines which connection method has been selected by the user via the displayed GUI screen. Specifically, in the case where "USB" has been selected, the processing proceeds to S610. In the case where "Wired LAN" has been selected, the processing proceeds to S611. In the case where "Wireless LAN (Manual)" has been selected, the processing proceeds to S612. In addition, in the case where "Easy connection" has been selected, the processing proceeds to S613. In the case where "Not set now" has been selected, the series of processing ends.

Here, as an example of the case where the reactivation of the main body of the printing apparatus 100 during the setting is unnecessary, a flow of processing in the case where "USB" has been selected in S609 will be described. In the case where "USB" has been selected in S609, in S610, the CPU 128 displays GUI screens 710 which prompt connecting a USB cable. The GUI screens 710 is a group of a plurality of still screens functioning as USB connection guide screens, and in S610, the plurality of still screens are sequentially displayed. After S610, the series of processing ends, and the CPU 128 displays a GUI screen 711, which is a print standby screen.

Next, as an example of the case where the reactivation of the main body of the printing apparatus 100 is necessary during the setting, the processing of S613 in the case where "Easy connection" has been selected in S609 will be described. This processing is, specifically, processing in the case where "Wi-Fi connection" has been selected via the GUI screen 709, and "Easy connection" has been selected via a GUI screen 801 (FIG. 8) which is displayed in accordance with this selection.

In S613, the CPU 128 displays a GUI screen 802. The user who has seen the GUI screen 802 instructs reactivation by pressing down a "Yes" button in the GUI screen 802. In the case where the input of pressing down this "Yes" button is received, the CPU 128 displays a GUI screen 803 indicating that setting is ongoing. After the setting ends, the main body of the printing apparatus 100 is reactivated, and the CPU 128 displays a GUI screen 804. After the reactivation processing is completed, the CPU 128 displays a GUI screen 805 for explaining a procedure of Easy connection. In the case where an input of pressing down a "Software" button in the GUI screen 805 is received, the CPU 128 displays a GUI screen 806 which is a guide screen for installing software. Thereafter, in the case where the user has executed a predetermined operation on the host PC side, the printing apparatus 100 is automatically reactivated, and the CPU 128 displays a GUI screen 807. After the reactivation, the CPU 128 displays a GUI screen 808 which is a standby screen.

### Other Embodiments

Although the aforementioned embodiments have been described by giving the printing apparatus as an example, the configuration is not limited to this. The technology of the present disclosure can be also applied to an information processing apparatus as a generic concept of a printing apparatus. This information processing apparatus may be configured to be included in a printing apparatus, or may be configured separately from a printing apparatus. This information processing apparatus includes a control unit configured to execute preparation processing which is executed at an initial activation, and parameter setting processing of setting a parameter in accordance with a parameter setting method selected from a plurality of parameter setting methods. The plurality of parameter setting methods include a method which requires reactivation of the information processing apparatus during execution of the parameter setting processing when the information processing apparatus is initially activated, and a method which does not require the reactivation. While a parameter setting method is selected by the user or the like when the information processing apparatus is initially activated, in the case where the selected parameter setting method is a method which does not require reactivation, the control unit executes the preparation processing and the parameter setting processing in parallel. This makes it possible to shorten the time for the initial setup.

In the aforementioned embodiments, the mode in which the print preparation processing includes the ink filling processing, the head cleaning processing, and the nozzle position variation correcting processing has been described; however, the present disclosure is not limited to this mode. The technology of the present disclosure can be applied to a mode in which the print preparation processing includes at least one of the ink filling processing, the head cleaning processing, and the nozzle position variation correcting processing.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

According to the present disclosure, it is possible to shorten the time for an initial setup of an information processing apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-060582, filed April 1, 2025, which is hereby incorporated by reference wherein in its entirety.

What is claimed is:

1. An information processing apparatus comprising:
a processor; and
a memory storing instructions that, when executed by the processor, cause the processor to perform operations comprising:
executing preparation processing, and
executing parameter setting processing of setting a parameter in accordance with a parameter setting method selected from a plurality of parameter setting methods, wherein
in a case where a parameter setting method selected from the plurality of parameter setting methods is a method which does not require reactivation, the preparation processing and the parameter setting processing are executed in parallel.

2. The information processing apparatus according to claim 1, wherein the plurality of parameter setting methods include: a method which requires reactivation during execution of the parameter setting processing at a time of initial activation; and a method which does not require the reactivation.

3. The information processing apparatus according to claim 1, wherein
in a case where a parameter setting method selected at a time of initial activation is a method which does not require the reactivation, the preparation processing and the parameter setting processing are executed in parallel.

4. The information processing apparatus according to claim 1, wherein
the parameter setting methods are methods for setting a connection parameter required for connecting with an external apparatus.

5. The information processing apparatus according to claim 4, the operations further comprising:
displaing a screen configured to receive an operation of selecting a parameter setting method from the plurality of parameter setting methods.

6. The information processing apparatus according to claim 5, wherein
the method which does not require the reactivation includes a parameter setting method relating to USB connection, a parameter setting method relating to wired LAN connection, and a parameter setting method relating to manual wireless LAN connection.

7. The information processing apparatus according to claim 3, wherein
the initial activation is activation in a case where a power supply to a main body is initially turned on after installation into a user environment.

8. The information processing apparatus according to claim 7, further comprising a storage unit, wherein
the storage unit stores information indicating whether or not an initial power supply has been turned on after the installation into the user environment, and
the operations further comprising:
determining, by using the information,whether or not activation by the latest turning on of the power supply is the initial activation.

9. A printing apparatus comprising the information processing apparatus according to claim 1.

10. The printing apparatus according to claim 9, wherein
the preparation processing is print preparation processing.

11. The printing apparatus according to claim 10, further comprising a head, wherein
the print preparation processing includes at least one of ink filling processing, head cleaning processing of cleaning the head, and nozzle position variation correcting processing for the head.

12. A control method for an information processing apparatus including a control unit configured to execute preparation processing and parameter setting processing of setting a parameter in accordance with a parameter setting method selected from a plurality of parameter setting methods, the control method comprising:
in a case where a parameter setting method selected from the plurality of parameter setting methods is a method which does not require reactivation, causing the control unit to execute the preparation processing and the parameter setting processing in parallel.

13. A non-transitory computer readable storage medium storing a program for causing a computer to execute a control method for an information processing apparatus including a control unit configured to execute preparation processing and parameter setting processing of setting a parameter in accordance with a parameter setting method selected from a plurality of parameter setting methods, the control method comprising:
in a case where a parameter setting method selected from the plurality of parameter setting methods is a method which does not require reactivation, causing the control unit to execute the preparation processing and the parameter setting processing in parallel.
